(19) United States
(12) Patent Application Publication
(10) Pub. No.: US 2021/0038461 A1
(43) Pub. Date: Feb. 11, 2021

(54) HAND EXERCISER DEVICES, SYSTEMS, AND METHODS

(71) Applicant: Clarence Johnson, Richfield, MN (US)

(72) Inventor: Clarence Johnson, Richfield, MN (US)

(21) Appl. No.: 16/988,370

(22) Filed: Aug. 7, 2020

Related U.S. Application Data
(60) Provisional application No. 62/922,423, filed on Aug. 8, 2019.

(51) Int. Cl. A61H 1/02

(52) U.S. Cl. CPC A61H 1/0288; A61H 2201/1638; A61H 2201/0119; A61H 2201/5058; A61H 2201/5035; A61H 2201/0207; A61H 2201/0184

(57) ABSTRACT

Disclosed herein are devices, systems, and methods relating to A hand exerciser assembly can include a base, a hand exerciser, a hand attachment mechanism, and a hand exerciser engine. The base can be configured to support the hand exerciser assembly. The hand exerciser can be coupled to the base and configured to removably receive a hand of a user and to exercise hand, wrist, or both muscle groups and to isolate a digit of the hand to be exercised. The hand attachment mechanism coupled to the hand exerciser and configured to secure the hand to the hand exerciser. The hand exerciser engine operatively coupled to the hand exerciser and configured to cause the hand exerciser to exercise the hand.

### CROSS-REFERENCE TO RELATED APPLICATIONS

The present application claims priority to U.S. Patent Application No. 62/922,423, filed Aug. 8, 2019, the entire disclosure of which being expressly incorporated herein by reference.

### FIELD OF THE DISCLOSURE

The present disclosure generally relates to exercise machines and, in particular, to exercise machines for a hand of a user.

### BACKGROUND

Conditioning of a patient's hand is an important consideration to building or maintaining a patient's dexterity. Among other things, circumstances that can compromise a patient's hand conditioning are injuries and diseases. Common among these circumstances are arthritis, which is a painful swelling and stiffening of a patient's joint due to eroding cartilage therein; strokes, which compromise motor functions due to compromised blood flow to the patient's brain; and trauma, such as fractures in the hand or other injuries to the hand. Often, treatment or maintenance of the hand under these circumstances includes some isolation or combination of regaining, building, or maintaining flexibility and strength in the hand. These activities can be performed, for example, as part of physical therapy or as a convenience for the patient. Treatment and maintenance, however, are usually painful, inconvenient, or both for the patient and are therefore, to the patient's detriment, are threatened not to occur frequently enough if at all.

### SUMMARY

The present disclosure generally relates to devices, systems, and methods involving exercisers, for example, that are useful in exercising a patient's hand. According to principles of the present disclosure, a patient's hand is exercised by isolated or harmonious movement of components of the hand, risk, of both. For example, the patient's digits (e.g., fingers and thumbs) can be secured to a hand exerciser assembly that will selectively modulate both the temperature and movement of the hand to the patient's discretion. Various examples of the present disclosure include at least one of heating and cooling the patient's hand before, during, or after movement of the hand. Movement of a hand exerciser in the hand exerciser assembly can cause movement of the patient's hand. Coordination and speed of such movement, for example, can include at least one of opening and closing the hand and can be ascribed to a particular exercise or routine to be performed by the hand exerciser assembly. To operate, such exercises or routines can be selected by a user, who can be the patient, care professional, medical professional, etc. Hand attachment mechanisms, such as straps or removable fasteners similar to hook-and-loop fasteners, can secure the hand to the hand attachment assembly. In examples, a temperature conducting material (e.g., steel, copper, or both) can be included in the hand exerciser assembly and can be used in at least one of heating and cooling the hand. Each operation (e.g., modulating temperature and movement) can be selected at the hand exerciser assembly, for example, via one or more switches thereat.

Numerous advantages are afforded by use of the present disclosure. For example, the present disclosure can modulate temperature and movement in concert (e.g., alone or together) per user discretion. In examples, to soothe the patient and to facilitate movement, it can be beneficial to heat the patient's hand before or during movement of the hand. Movement ascribed to an exercise or routine can be performed by the hand exerciser assembly without requiring the patient to move their hand after it is secured to the hand exerciser assembly. Independent of the patient's range of motion, the hand exerciser assembly can cause the patient's hand to move beyond the patient's range of motion to thereby increase the flexibility of the hand.

In accordance with examples of the present disclosure, a hand exerciser assembly can include a base, a hand exerciser, a hand attachment mechanism, and a hand exerciser engine. The base can be configured to support the hand exerciser assembly. The hand exerciser can be coupled to the base and configured to removably receive a hand of a user and to exercise hand, wrist, or both muscle groups and to isolate a digit of the hand to be exercised. The hand attachment mechanism coupled to the hand exerciser and configured to secure the hand to the hand exerciser. The hand exerciser engine operatively coupled to the hand exerciser and configured to cause the hand exerciser to exercise the hand.

The hand exerciser assembly can include a controller to controllably move the hand exerciser to exercise the hand. The hand exerciser assembly can include a non-transitory computer readable storage medium having a plurality of instructions stored thereon that, when executed by the controller, can cause the controller to receive a selection of an exercise to perform on the hand exerciser, to alert the user of a selected exercise, and to controllably move the hand exerciser to exercise the hand according to the selected exercise. The plurality of instructions stored on the non-transitory computer readable storage medium, when executed by the controller, can cause the controller to receive a speed at which the to perform a selected exercise, to alert the user of the speed of the selected exercise, and to cause the hand exerciser to perform the selected exercise at the speed. The plurality of instructions stored on the non-transitory computer readable storage medium, when executed by the controller, can cause the controller to receive a selected hand size of the hand and to adjust the exercise based on the selected hand size.

In accordance with examples of the present disclosure, a method can exercise a hand of a user, according to principles of the present disclosure. The method can include removably receiving a hand of a user at a hand exerciser. The method can include securing the hand to the hand exerciser via a hand attachment mechanism. The method can include exercising, mechanically, hand muscle groups of the hand via a hand exerciser engine causing, non-mechanically, the hand and exerciser engine to move.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein;

FIG. 1A is a perspective view of a hand exerciser assembly with a single hand exerciser, in accordance with aspects of the present disclosure;

FIG. 1B is a perspective view of a hand exerciser assembly with two hand exercisers, in accordance with aspects of the present disclosure;

FIG. 1C is a perspective view of hand exercisers for a hand exerciser assembly, in accordance with aspects of the present disclosure;

FIG. 2 is a diagram of hand exercisers for a hand exerciser assembly, in accordance with aspects of the present disclosure; and

FIG. 3 is a flowchart of a method of exercising a hand of a patient, in accordance with aspects of the present disclosure.

Although the drawings represent embodiments of the various features and components according to the present disclosure, the drawings are not necessarily to scale and certain features can be exaggerated in order to better illustrate and explain the present disclosure. The exemplification set out herein illustrates embodiments of the disclosure, and such exemplifications are not to be construed as limiting the scope of the disclosure in any manner.

### DETAILED DESCRIPTION OF EMBODIMENTS OF THE DISCLOSURE

For the purpose of promoting an understanding of the principles of the disclosure, reference will now be made to the embodiments illustrated in the drawings, which are described below. It will nevertheless be understood that no limitation of the scope of the disclosure is thereby intended. The disclosure includes any alterations and further modifications in the illustrated device and described methods and further applications of the principles of the disclosure, which would normally occur to one skilled in the art to which the disclosure relates. Moreover, the embodiments were selected for description to enable one of ordinary skill in the art to practice the disclosure.

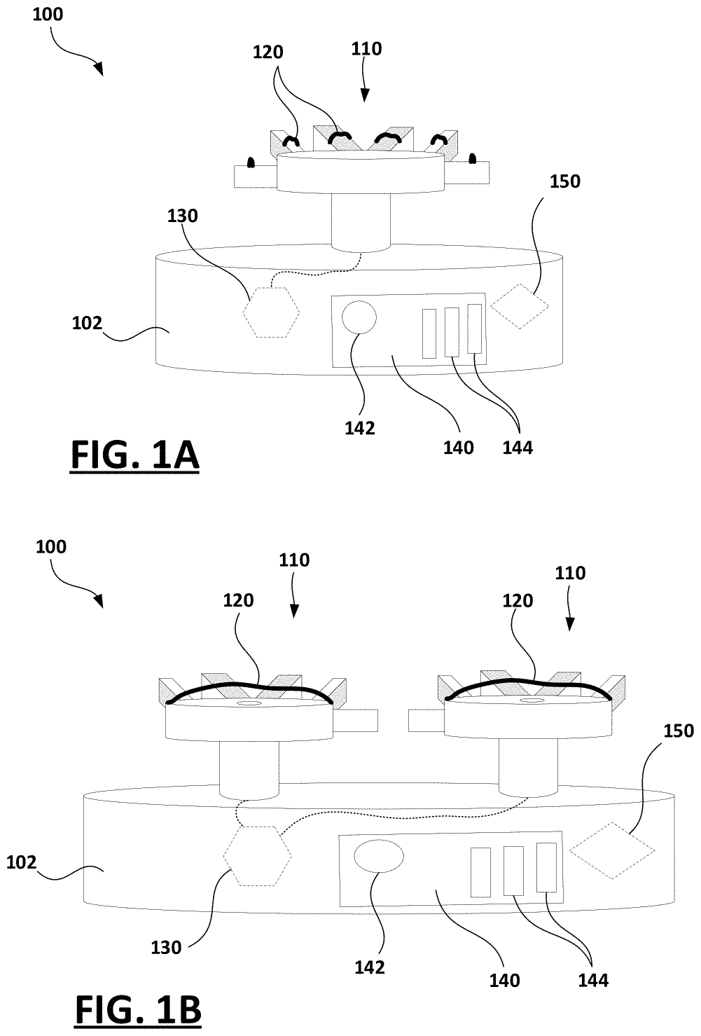

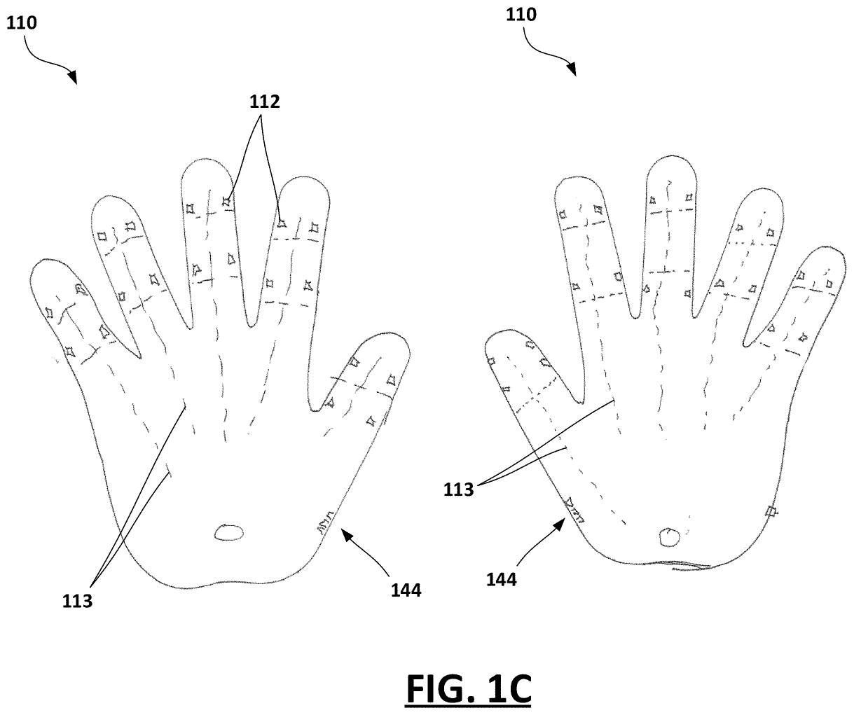

Referring now to the figures, FIG. 1A is a perspective view of a hand exerciser assembly 100 with a single hand exerciser 110, in accordance with aspects of the present disclosure. FIG. 1B is a perspective view of a hand exerciser assembly 100 with two hand exercisers 110, in accordance with aspects of the present disclosure. FIG. 1C is a perspective view of hand exercisers 110 for a hand exerciser assembly 100, in accordance with aspects of the present disclosure. While shown as a non-handheld assembly, it should be appreciated that the hand exerciser assembly 100 can be in handheld form without departing from the scope of this disclosure.

A hand exerciser assembly 100 can include a base 102, a hand exerciser 110, a hand attachment mechanism 120, and a hand exerciser engine 130. The base 102 can be relatively large (e.g., 20 inches square or around) and can be configured to support the hand exerciser assembly 100, for example, by resting on a support surface (not shown). The hand exerciser 110 can be coupled to the base 102 and configured to removably receive a hand (not shown) of a user (hereinafter referred to as “user” or “patient”) and to exercise hand, wrist, or both muscle groups and to isolate a digit of the hand to be exercised. The hand exerciser 110 can resemble the size and shape of a hand and, for example, have a width of about 1 inch wide for each digit. The hand muscle groups can include at least two of thenar, hypothenar, interossei, and lumbrical muscles. The hand attachment mechanism 120 coupled to the hand exerciser 110 and configured to secure the hand to the hand exerciser 110. The hand exerciser engine 130 operatively coupled to the hand exerciser 110 and configured to cause the hand exerciser 110 to exercise the hand.

Movable relative to the base 102, the hand exerciser 110 can be configured to move between an open position in which the hand is moves away from a fisted position (e.g., to an opened position) and a closed position in which the hand moves toward the fisted position. For example, the patient's hand can begin in a neutral position with digits spread but without any stress or forces acting thereon. Then, the hand exerciser 110 can move to the open position to upwardly stretch the digits and to the closed position to downwardly stretch the digits. In examples, moving to the open position can cause the digits to move upwardly above a plane extending laterally through the patient's hand. In examples, moving to the closed position can cause the digits to form a fist. Portions of the hand exerciser 110 can move in concert or in isolation. For example, the patient can choose to only exercise their thumb, index finger, or wrist. Exercising the wrist can comprise tilting the hand exerciser 110 relative to the base 102.

Movement of the hand exerciser 110 can be caused by fluid pumped from the hand exerciser engine 130 through portions of the hand exerciser 110 or driving actuators coupled to portions of the hand exerciser 110. In examples, the hand exerciser engine 130 can cause, non-mechanically, the hand exerciser engine 130 to move the hand exerciser 110 (e.g., between the open and closed positions) to thereby exercise the hand. In examples, the fluid comprises a hydraulic fluid and the hand exerciser engine 130 comprises a hydraulic pump configured to pump the hydraulic fluid. As shown in FIGS. 1A and 1B, the hydraulic pump and connected lines to the hand exerciser 110 are internal to the hand exerciser assembly 100, e.g., by being positioned within the base 102. However, it should be appreciated that the hydraulic pump and connected lines can be external to the hand exerciser assembly 100 without departing form the scope of the present disclosure. In examples, as shown in FIG. 1C, hydraulic lines 113 can extend through portions of the hand exerciser 110 that move the patient's digits.

Referring again to FIGS. 1A-1C, the hand exerciser 110 can be configured to transfer heat to the hand of the user. The heat can be transferred to the hand via a heat-transmitting material. For example, one or more portions (including the entirety) of the hand exerciser 110 can be a heat-transmitting metal, such as copper, steel, or conductive composite. In examples, the entire hand exerciser 110 comprises steel while in other examples only certain portions of the hand exerciser 110 (e.g., those that contact the hand or are position near a particular area of concern for the hand) comprises steel. Wires (not shown) connected to heat-transmitting portions of the hand exerciser 110 can supply power thereto to transmit hear. As noted below, a controller 150 may control various functions of the hand exerciser assembly 100. When the controller 150 causes heat to transfer to the hand of the user, the heat can be selectively transferred to at least one of one or more digits of the hand and a palm. In examples, a level (e.g., low, mid-low, medium, medium-high, high, etc.) of heat can be selected and performed by the hand exerciser assembly 100. In examples, the hand exerciser assembly 100 can similarly transmit cooling to the hand, e.g., in a routine for recovering after moving the hand with heat.

One or more alerts provided by the hand exerciser assembly 100 can facilitate safe and informed operation thereof. The alert can be at least one of an audible alert and a visual alert. For example, a user interface 140 can include a signal 142 that can be an audio speaker, a light, or any other form of alert. In embodiments, as show, the signal 142 can be included in the user interface 140, for example, near one or more switches 144 used to operate the hand exerciser assembly 100. In this way, the signal 142 and the switches 144 are conveniently located. The hand exerciser assembly 100 can include a safety sensor 114 (e.g., a touch or pressure sensor) configured to inhibit operation of the hand exerciser assembly 100 when the hand is not secured to the hand exerciser 110 with the hand attachment mechanism 120. The switches 144 can be hard or soft and interact with a controller 150 (as detailed further below) or directly modify operation of the hand exerciser assembly 100. Some switches 144 can include power switches, kill switches, speed switches, hand-size selection switches, temperature adjustment or selection switches, and the like. While shown positioned at the base 102, it should be appreciated that one or more components of the user interface 140 can be positioned elsewhere on the hand exerciser assembly 100 (e.g., on the hand exerciser 110 as shown in FIG. 1C) or external to the hand exerciser assembly 100.

Exercising the hand, in some examples, can occur after the hand is secured to the hand exerciser 110 via a hand attachment mechanism 120. Securing the hand can render the hand stationary relative to the hand exerciser 110. In examples, the hand attachment mechanism 120 can include one or more adjustable fasteners, one or more removable fasteners, or both. Such fasteners can be configured to secure individual digits (as shown in FIG. 1A), a palm of the hand (as shown in FIG. 1B), or both, for example. Any of these hand attachment mechanisms 120 can include hook-and-loop fasteners and can be secured at secure locations (e.g., apertures 112 in FIG. 1C) at the hand exerciser 110.

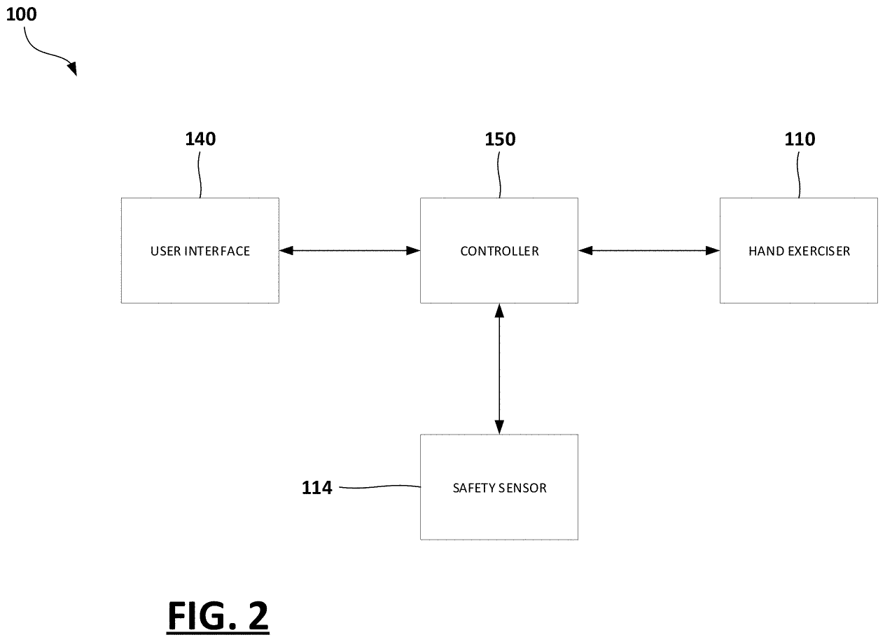

FIG. 2 is a diagram of a hand exerciser assembly 100, in accordance with aspects of the present disclosure. As shown here, the hand exerciser assembly 100 can include operatively connected circuitry, a segment of which is shown here, to operate. While some examples have one or more components in the segment shown here internal to the hand exerciser assembly 100, it should be appreciated that a portion or the entirety of the circuitry can be external to the hand exerciser assembly 100. In examples, the controller 150 can be or communicate with a remote, smart device, or the like. The circuitry can include a circuit board (not shown) and can be connected to a power source, e.g., a wall outlet or batteries. As shown here, the controller 150 is in communication (e.g., wireless or wired transmission) with the user interface 140, the hand exerciser 110, and the safety sensor 114.

Operation of the hand exerciser assembly 100 can be controlled by a controller 150. The hand exerciser assembly 100 can include the controller 150 to controllably move the hand exerciser 110 to exercise the hand. The controller 150 can include one or more processors (not shown). The selection of an exercise to perform on the hand exerciser 110 can include working a digit of the hand. The hand exerciser assembly 100 can include a non-transitory computer readable storage medium having a plurality of instructions stored thereon that, when executed by the controller 150, can cause the controller 150 to receive a selection of an exercise to perform on the hand exerciser 110, to alert the user of a selected exercise, and to controllably move the hand exerciser 110 to exercise the hand according to the selected exercise. The plurality of instructions stored on the non-transitory computer readable storage medium, when executed by the controller 150, can cause the controller 150 to receive a speed (e.g., slow, medium, fast, and the like) at which the to perform a selected exercise, to alert the user of the speed of the selected exercise, and to cause the hand exerciser 110 to perform the selected exercise at the speed. The plurality of instructions stored on the non-transitory computer readable storage medium, when executed by the controller 150, can cause the controller 150 to receive a selected hand size of the hand and to adjust the exercise based on the selected hand size. Any of these functions can be performed cyclically or on a routine without departing from the scope of this disclosure.

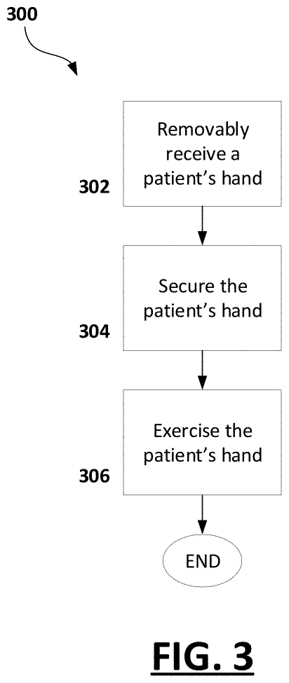

According to principles of the present disclosure, a method 300 of exercising a patient's hand is disclosed as shown in FIG. 3. The method 300 can employ a hand exerciser assembly (or components thereof) as disclosed elsewhere herein, including the hand exerciser assembly 100. To begin, at step 302, the method 300 can include removably receiving a hand of a patient at a hand exerciser. At step 304, the method 300 can include securing the hand to the hand exerciser via a hand attachment mechanism. At step 306, the method 300 can include exercising, mechanically, hand muscle groups of the hand via a hand exerciser engine causing, non-mechanically, the hand and exerciser engine to move.

Some examples of the hand exerciser can employ a controller for programming or controlling certain functions of the method 300. In examples, the method 300 can include receiving, via the controller, a selection of an exercise to perform on the hand exerciser. In examples, the method 300 can include alerting, via the controller, the patient of a selected exercise, wherein the alert is at least one of an audible alert and a visual alert. In examples, the method 300 can include moving, via the controller, the hand exerciser to exercise the hand according to the selected exercise. In examples, the hand exerciser engine can cause, non-mechanically, the hand exerciser engine to move the hand exerciser to thereby exercise the hand comprises using a hydraulic fluid and wherein the hand exerciser engine comprises a hydraulic pump configured to pump the hydraulic fluid. In examples, the method 300 can include receiving a speed at which the to perform a selected exercise, alerting the patient of the speed of the selected exercise, and causing the hand exerciser to perform the selected exercise at the speed. The method can include selecting a hand size of the hand and adjusting the exercise based on the hand size.

The connecting lines shown in the various figures contained herein are intended to represent exemplary functional relationships and/or physical couplings between the various elements. It should be noted that many alternative or additional functional relationships or physical connections can be present in a practical system. However, the benefits, advantages, solutions to problems, and any elements that can cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone can be present in an embodiment, B alone can be present in an embodiment, C alone can be present in an embodiment, or that any combination of the elements A, B or C can be present in a single embodiment; for example, A and B, A and C, B and C, or A and B and C.

In the detailed description herein, references to “one embodiment,” “an embodiment,” “an example embodiment,” etc., indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus

While the embodiments have been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this invention pertains.

What is claimed is:

1. A hand exerciser assembly comprises:
a hand exerciser configured to couple to a base and to removably receive a hand of a user and to exercise hand, wrist, or both muscle groups and to isolate a digit of the hand to be exercised;
a hand attachment mechanism coupled to the hand exerciser and configured to secure the hand to the hand exerciser; and
a hand exerciser engine operatively coupled to the hand exerciser and configured to cause the hand exerciser to exercise the hand.

2. The hand exerciser assembly of claim 1, further comprising the base configured to support the hand exerciser assembly.

3. The hand exerciser assembly of claim 1, wherein the hand attachment mechanism includes one or more adjustable fasteners.

4. The hand exerciser assembly of claim 1, wherein the hand attachment mechanism includes one or more removable fasteners.

5. The hand exerciser assembly of claim 1, further comprising a controller to controllably move the hand exerciser to exercise the hand.

6. The hand exerciser assembly of claim 5, further comprising a non-transitory computer readable storage medium having a plurality of instructions stored thereon that, when executed by the controller, cause the controller to receive a selection of an exercise to perform on the hand exerciser, to alert the user of a selected exercise, and to controllably move the hand exerciser to exercise the hand according to the selected exercise.

7. The hand exerciser assembly of claim 6, wherein the alert is at least one of an audible alert and a visual alert.

8. The hand exerciser assembly of claim 6, wherein the plurality of instructions stored on the non-transitory computer readable storage medium, when executed by the controller, further cause the controller to receive a speed at which the to perform the selected exercise, to alert the user of the speed of the selected exercise, and to cause the hand exerciser to perform the selected exercise at the speed.

9. The hand exerciser assembly of claim 6, wherein the selection of an exercise to perform on the hand exerciser includes working one or more digits of the hand.

10. The hand exerciser assembly of claim 6, wherein the plurality of instructions stored on the non-transitory computer readable storage medium, when executed by the controller, further cause the controller to receive a selected hand size of the hand and to adjust the exercise based on the selected hand size.

11. The hand exerciser assembly of claim 1, further comprising a safety sensor configured to inhibit operation of the hand exerciser assembly when the hand is not secured to the hand exerciser with the hand attachment mechanism.

12. The hand exerciser assembly of claim 1, wherein the hand exerciser is configured to transfer heat to the hand of the user, and wherein a controller is configured to cause the hand exerciser to transfer heat to the hand of the user.

13. The hand exerciser assembly of claim 12, wherein when the controller causes the heat to transfer to the hand of the user, the heat is selectively transferred to at least one of one or more digits of the hand and a palm.

14. The hand exerciser assembly of claim 12, wherein the heat is transferred to the hand via a heat-transmitting material.

15. The hand exerciser assembly of claim 1, wherein the hand exerciser is configured to move between an open position in which the hand is moves away from a fisted position and a closed position in which the hand moves toward the fisted position.

16. A method of exercising a hand of a user, the method comprises:
removably receiving the hand of the user at a hand exerciser;
securing the hand to the hand exerciser via a hand attachment mechanism;
exercising, mechanically, hand muscle groups of the hand via a hand exerciser engine causing, non-mechanically, the hand exerciser engine to move the hand exerciser to thereby exercise the hand.

17. The method of claim 16, further comprising:
receiving, via a controller, a selection of an exercise to perform on the hand exerciser;
alerting, via the controller, the user of a selected exercise, wherein an alert is at least one of an audible alert and a visual alert; and
moving, via the controller, the hand exerciser to exercise the hand according to the selected exercise.

18. The method of claim 17, wherein the hand exerciser engine causing, non-mechanically, the hand exerciser engine to move the hand exerciser to thereby exercise the hand comprises using a hydraulic fluid and wherein the hand exerciser engine comprises a hydraulic pump configured to pump the hydraulic fluid.

19. The method of claim 17, further comprising:
receiving a speed at which the to perform the selected exercise;
alerting the user of the speed of the selected exercise; and
causing the hand exerciser to perform the selected exercise at the speed.

20. The method of claim 16, further comprising selecting a hand size of the hand and adjusting the exercise based on the hand size.
